(19) United States
(12) Patent Application Publication
(10) Pub. No.: US 2026/0146696 A1
(43) Pub. Date: May 28, 2026

(54) AXIS PUSH TYPE WATERPROOF CONNECTOR SET AND FEMALE WATERPROOF CONNECTOR THEREOF

(71) Applicant: ACES ELECTRONICS CO., LTD., Taoyuan City (TW)

(72) Inventors: Rong-Hsun KUO, Taoyuan City (TW); Chiau-Hsin TSOU, Taoyuan City (TW)

(21) Appl. No.: 19/311,279

(22) Filed: Aug. 27, 2025

(30) Foreign Application Priority Data
Nov. 22, 2024 (TW) 113145227

(51) Int. Cl. F16L 37/32; F16L 37/084

(52) U.S. Cl. CPC F16L 37/32; F16L 37/0847

(57) ABSTRACT

A female waterproof connector has a first tube, a pressed buckle, a press-proof member. The pressed buckle has a pressing portion and an engaging portion. The press-proof member has a pushing portion and a block portion. The pushing portion is free from being overlapped with the pressed buckle in a radial direction of the first tube. When the block portion is moved to the first position of the outer side of the first tube, the pressing portion is moved relative to the first tube at a first distance in the radial direction. When the block portion is moved to the second position, the pressing portion is moved relative to the first tube at a second distance, wherein the second distance is shorter than the first distance.

### CROSS-REFERENCE TO RELATED APPLICATIONS

This application is based upon and claims priority under 35 U.S.C. 119 from Taiwan Patent Application No. 113145227 filed on Nov. 22, 2024, which is hereby specifically incorporated herein by this reference thereto.

### BACKGROUND OF THE INVENTION

### 1. Field of the Invention

The present invention relates to a waterproof connector, and more particularly to an axis push type waterproof connector that can prevent water leakage due to accidental contact.

### 2. Description of the Prior Arts

With reference to FIG. 7A, a conventional waterproof connector set comprises a female waterproof connector 80 and a male waterproof connector 90. The female waterproof connector 80 comprises a first tube 81, a first valve 82, a first tube connector 83, and a pressed buckle 84. The first valve 82 is mounted axially movably in the first tube 81. The pressed buckle 84 is mounted on the first tube 81 at a position approaching to a front opening 811 of the first tube 81 and extends diametrically through the first tube 81. The pressed buckle 84 is diametrically movable relative to first tube 81. A rear opening 812 of the first tube 81 connects to and communicates with the first tube connector 83 that connects to a water tube 85.

The male waterproof connector 90 comprises a second tube 91, a second valve 92, a second tube connector 93. The second valve 92 is mounted axially movably in the second tube 91. A rear opening 912 of the second tube 91 connects to and communicates with the second tube connector 93 that connects to another water tube 94.

To insert the male waterproof connector 90 into the female waterproof connector 80, first, the pressed buckle 84 is pressed to move diametrically relative to the first tube 81 until an insertion portion 911 of the second tube 91 is completely inserted into the first tube 81 via the front opening 811 of the first tube 81, as shown in FIG. 7B. The pressed buckle is released and is engaged with the second tube 91 inserted inside the first tube 81. During the insertion, the second valve 82 contacts with the first valve to push the first valve 82 to move away from the front opening 811 of the first tube 81. Thus, the second tube connects to and communicates with the first tube to form a waterway.

When the male waterproof connector 90 is disengaged from the female waterproof connector 80, the water sources from the water tubs 85, 94 are closed first. The pressed buckle 84 is then pressed. The male waterproof connector 90 can be disengaged from the female waterproof connector 80 smoothly without leaking by operating the aforementioned processes in reverse order. However, the pressed buckle 84 is arranged on an outer side of the first tube 81 of the female waterproof connector 80 The male waterproof connector 90 is disengaged from the female waterproof connector 80 to cause leakage before the pressed buckle 84 is completely engaged with the second tube 91 of the male waterproof connector 90 due to accident contact.

To overcome the shortcomings, the present invention provides an axis push type waterproof connector assembly to mitigate or to obviate the aforementioned problems.

### SUMMARY

The objective of the present invention is to provide a contact-proof axis push type waterproof connector assembly and a female waterproof connector thereof.

To achieve the aforementioned objective, the present invention provides an axis push type waterproof connector assembly having a female waterproof connector and a male waterproof connector selectively inserted into the female waterproof connector, wherein a pressed buckle of the female waterproof connector is disposed on an outer side of a first tube of the female waterproof connector at a spaced interval, a second tube of the male waterproof connector held in the female waterproof connector is engaged with or disengaged from the pressed buckle by a diametrical movement of the pressed buckle, wherein
a press-proof member is mounted on the outer side of the first tube of the female waterproof connector and comprises
   a pushing portion mounted longitudinally moveably on the outer side of the first tube and being free from being overlapped with the pressed buckle in a radial direction of the first tube; and
   a block portion integrally protruding from a front end of the pushing portion and being movable with the pushing portion between a first position and a second position of the outer side of the first tube, wherein
when the block portion is moved to the first position of the outer side of the first tube, the pressing portion of the pressed buckle is moved relative to the outer side of the first tube at a first distance in the radial direction of the first tube; and
when the block portion is moved to the second position of the outer side of the first tube, the pressing portion of the pressed buckle is moved relative to the outer side of the first tube at a second distance in the radial direction of the first tube, wherein the second distance is shorter than the first distance.

With such an arrangement, the axis push type waterproof connector assembly mainly applies a press-proof member longitudinally movable onto the outer side of the first tube of the female waterproof connector. When the pushing portion of the press-proof member is pushed by a user's finger, the block portion is moved between the first position and the second position. The moving distance of the pressing portion of the press-proof member relative to the outer side of the first tube can be adjusted. This means that after the axis push type waterproof connector assembly is assembled, the press-proof member is moved to the second position to limit the diametrical movable distance of the pressed buckle so that it is not enough to disengage the male waterproof connector from the female waterproof connector.

To achieve the aforementioned adjective, the present invention also provides another female waterproof connector having
a first tube comprising a first front opening and a first rear opening;
a pressed buckle comprising a pressing portion and an engaging portion, wherein the pressing portion is mounted on an outer side of the first tube at a spaced interval, the engaging portion protruding integrally from the pressing portion, extending diametrically through the first tube, and being approaching to the first front opening of the first tube;
a press-proof member mounted on the outer side of the first tube and comprising
   a pushing portion mounted longitudinally slidably on the outer side of the first tube and is free from being overlapped with the pressed buckle in a radial direction of the first tube; and
   a block portion protruding integrally from a front end of the pushing portion and pushed by the pushing portion to move between a first position and a second position on the outer side of the first tube, wherein
when the block portion is moved to the first position of the outer side of the first tube, the pressing portion of the pressed buckle is moved relative to the outer side of the first tube at a first distance in the radial direction of the first tube; and
when the block portion is moved to the second position of the outer side of the first tube, the pressing portion of the pressed buckle is moved relative to the outer side of the first tube at a second distance in the radial direction of the first tube, wherein the second distance is shorter than the first distance.

With such an arrangement, a press-proof member is applied longitudinally movable onto an outer side of the first tube of the female waterproof connector in accordance with the present invention. When the pushing portion of the press-proof member is pushed by a finger of a user, the block portion is moved between the first position and the second position. The moving distance of the pressing portion of the press-proof member relative to the outer side of the first tube can be adjusted. This means that after the axis push type waterproof connector assembly is assembled, the press-proof member is moved to the second position to limit the diametrical movable distance of the pressed buckle so that it is not enough to disengage the male waterproof connector from the female waterproof connector.

### BRIEF DESCRIPTION OF THE DRAWINGS

FIG. 1 is a perspective view of a first embodiment of a waterproof connector assembly in accordance with the present invention;

FIG. 2 is an exploded perspective view of the waterproof connector assembly in FIG. 1;

FIG. 3 an exploded perspective view in partial section of the waterproof connector assembly in FIG. 1;

FIGS. 4A to 4C show operational cross sectional side views of the waterproof connector assembly in FIG. 1;

FIGS. 5A and 5B show operational side views of a second embodiment of a waterproof connector assembly in accordance with the present invention;

FIGS. 6A and 6B show operational side views of a third embodiment of a waterproof connector assembly in accordance with the present invention;

FIGS. 6C and 6D show operational side views of a fourth embodiment of a waterproof connector assembly in accordance with the present invention;

FIG. 7A is an exploded cross sectional side view of a conventional waterproof connector assembly; and

FIG. 7B is a cross sectional side view of the conventional waterproof connector assembly in FIG. 7A.

### DETAILED DESCRIPTION OF THE EMBODIMENTS

The present invention is related to an axis push type waterproof connector assembly for water tubes, such as liquid cooling tube connection of liquid cooling radiator, but not limited thereto. Other objectives, advantages and novel features of the invention will become more apparent from the following detailed description when taken in conjunction with the accompanying drawings.

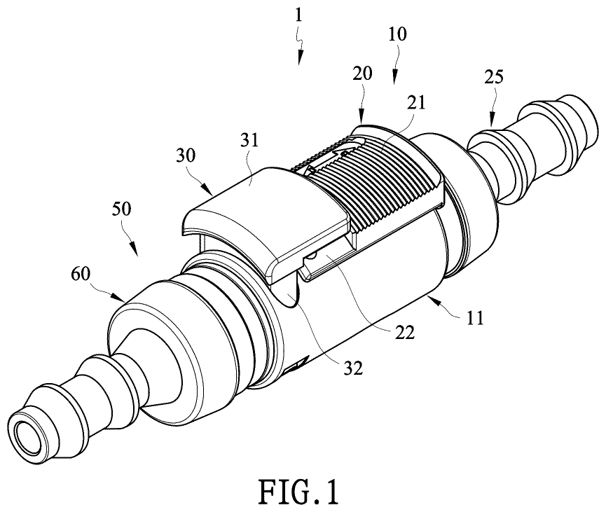

With reference to FIG. 1, the axis push type waterproof connector assembly in accordance with the present invention comprises a female waterproof connector 10 and a male waterproof connector 50 selectively inserted into the female waterproof connector 10.

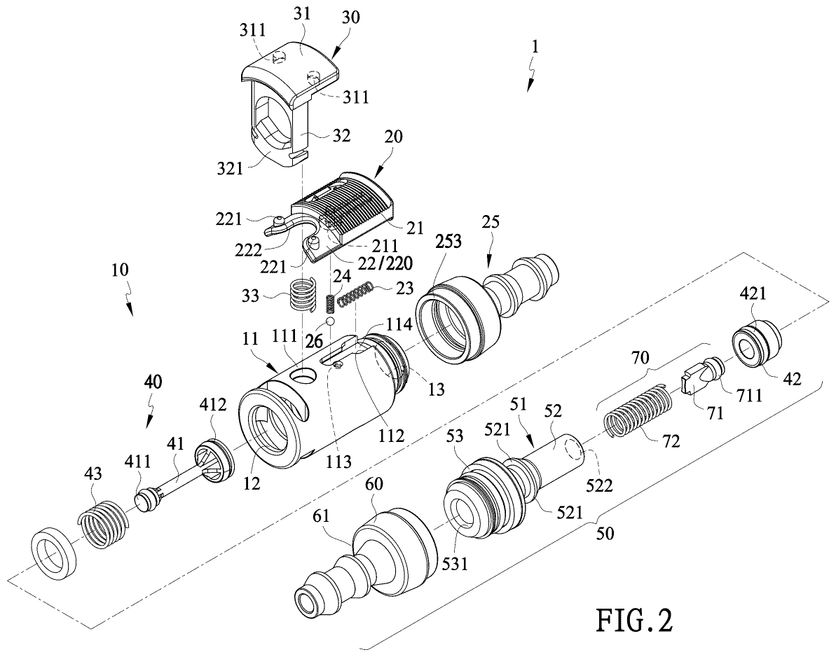

With further reference to FIG. 2, the female waterproof connector 10 comprises a first tube 11, a press-proof member 20, a pressed buckle 30, a first water connector 25, and a first valve 40. The pressed buckle 30 is mounted on an outer side 111 of the first tube 11 and extends diametrically through the first tube 11. The first water connector 25 is mounted around the first tube 11. The first valve 40 is held in the first tube 11.

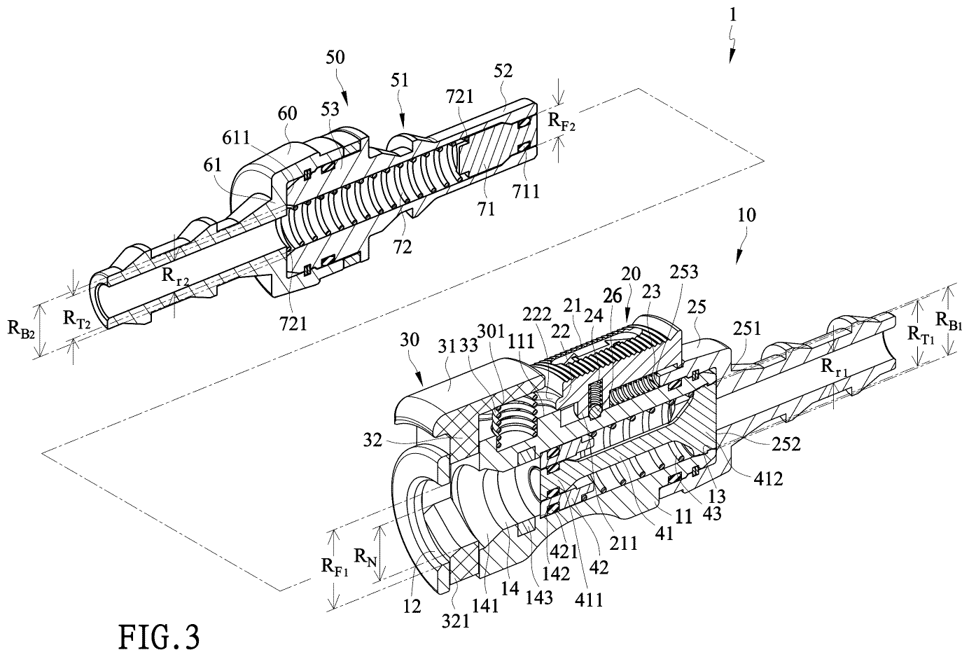

The first tube 11 has a first front opening 12 and a first rear opening 13. The first front opening 12 is applied to be inserted by the male waterproof connector 50. The first rear opening 13 communicates with the first water tube 25. With further reference to FIG. 3, an inner wall of the first tube 11 has a diameter R_{T1}. A neck flange 14 protrudes from an inner surface of the first tube 11 at a position being approaching to the first front opening 12. An inner surface of the neck flange 14 has a diameter R_{N}, two opposite surfaces, and a flat surface. The two opposite surfaces include an inclined surface 141 facing the first front opening 12 and a vertical surface 142 facing the first rear opening 13. A first seal 143 is embedded in the flat surface. As shown in FIG. 3, the diameter R_{T1} of the inner wall of the first tube 11 is larger than the diameter R_{N} of the inner surface of the first tube 11 but is smaller than a diameter R_{F1} of the first front opening 12 (R_{F1}>R_{T1}>R_{N}). In the first embodiment, a holding recess 112 and a positioning recess 113 are defined in the outer side 111 of the first tube 11, and the positioning recess 113 is defined in a bottom 114 of the holding recess 112.

With reference to FIGS. 2 and 3, the press-proof member 20 includes a pushing portion 21 and a block portion 22. The pushing portion 21 is mounted longitudinally moveably on the outer side 111 of the first tube 11. The block portion 22 is integrally formed on and protrudes from a front end of the pushing portion 21 and is movable between a first position and a second position on the outer side 111 of the first tube 11 by the pushing portion 21. In the present embodiment, the first position is more close to the first front opening 12 than the second position. The block portion 22 includes a board body 220 and at least one stub 221 integrally formed on the board body 220. The board body 220 abuts with the outer side of the first tube 11 and has a thickness thinner than that of the pushing portion 21. In one embodiment, the pushing portion 21 is mounted moveably in the holding recess 112 and has a sliding block 211 protruding toward the holding recess 112 and flatly attached to the bottom 114 of the holding recess 112. In the present embodiment, a notch 222 is formed in a front end and toward a rear end of the board body 220, and two stubs are formed on the board body 220 and respectively located on two sides of the notch 222.

In addition, the press-proof member 20 further comprises a second resilient member 23, a third resilient member 24, and a positioning ball 26. The second resilient member 23 is mounted longitudinally between the pushing portion 21 and an inner wall of the holding recess 112. The second resilient member 23 has two ends, one of the two ends abuts with a front edge 253 of the first tube connector 25, and the other end abuts with the sliding block 211. The third resilient member 24 is mounted in the sliding block 211 in a radial direction of the first tube 11. The positioning ball 26 is held in the positioning recess 113 and is pushed by the third resilient member 24.

With reference to FIGS. 1 and 3, the pressed buckle 30 includes a pressing portion 31, an engaging portion 32, and a first resilient member 33. The pressing portion 31 is disposed on the outer side 111 of the first tube 11 of the female waterproof connector at a spaced interval, such that the pressed buckle 30 can be radially moved to be engaged with or to be released from a portion of the male waterproof connector 50 held in the female waterproof connector 10. The pressing portion 31 is not overlapped with the pushing portion of the press-proof member 20 in the radial direction of the first tube 11 but is overlapped with the board body 220 of the block portion 22 of the press-proof member 20 in the radial direction. The board body 220 of the board body 22 is spaced from an inner surface 301 of the pressing portion 31. The engaging portion 32 integrally protrudes from the pressing portion 31 and extends radially through the first tube 11 to approach the first front opening 12 and being in front of the neck flange 14. The first resilient member 33 is mounted between the inner surface 301 of the pressing portion 31 and the outer side 111 of the first tube 11 to provide a restoring force to the pressing portion 31 after the pressing portion 31 being released from being pressed. In the first embodiment, the pressing portion 31 has a thickness and is overlapped with the block portion 22 of the press-proof member 20 in the radial direction. At least one cavity 331 is formed in the inner surface 301 respectively at a position corresponding to the at least one stub 221 on the block portion 22. The thickness of the pressing portion 31 is larger than a depth of the cavity 311. The first resilient member 33 is more close to first front opening 12 than the first position. The first resilient member 33 is located at a position corresponding to the notch 222 in the board body 220 of the block portion 22, such that the first resilient member 33 can extend through the notch 222 and is not interfered with the block portion 22. As shown in FIG. 3, when the pressing portion is released, a lower portion 321 of the engaging portion 32 moves upward and located in the first tube 11.

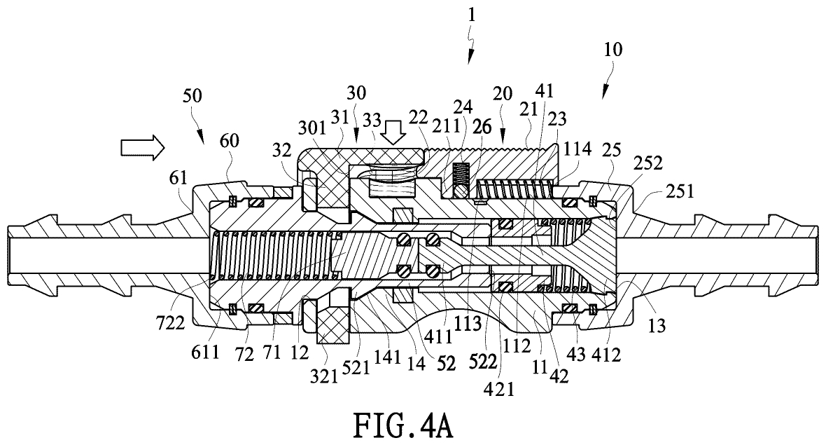

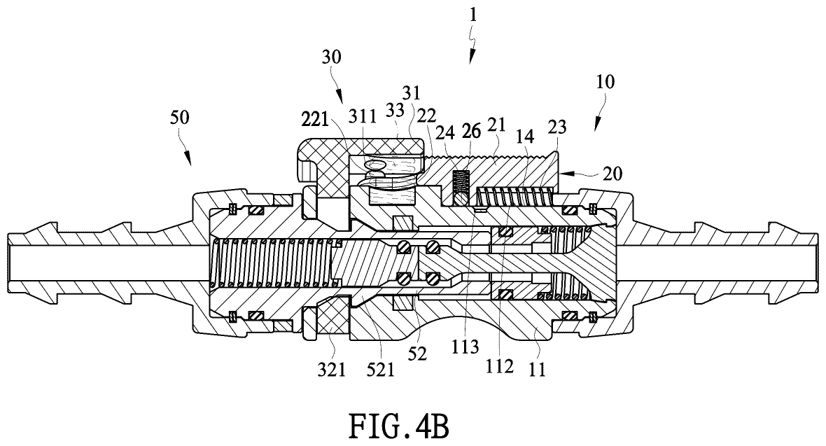

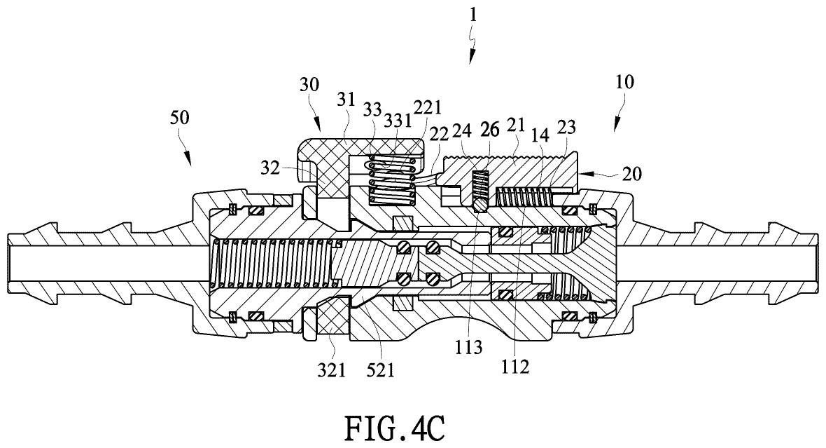

With reference to FIGS. 3, 4A, and 4B, to insert the male waterproof connector 50 into the female waterproof connector 10, the pushing portion 21 that is not overlapped with the pressing portion 31 is pushed by a finger of a user, and the block portion 22 is moved to the first position. At this time, the positioning ball 26 is moved longitudinally from the positioning recess 113 to the bottom 114 of the holding recess 112. The block portion 22 is located between the pressing portion 31 and the outer side 111 of the first tube 11, and the two stubs 221 on the block portion 22 are respectively aligned with the cavities 311. The pressing portion 31 is then pressed, and the stubs 211 on the block portion 22 will be engaged respectively with the cavities 311 in the pressing portion 31. Thus, the pressing portion 31 is approaching to the outer side 111 of the first tube 11, and the lower portion 321 of the engaging portion 32 is not located in the first tube 11. Accordingly, the male waterproof connector 50 can be inserted into the female waterproof connector 10 smoothly without interfering. As shown in FIG. 4B, after the male waterproof connector 50 is inserted into the female waterproof connector 10, the pressing portion 31 is released, the restoring force provided by the compressed first resilient member 33 pushes the pressing position to move upward to the original position. As shown in FIG. 4C, to prevent the male waterproof connector 50 from being disengaged from the female waterproof connector 10 due to the pressing portion 31 being in contact, the pushing portion 21 of the press-proof member 20 is moved toward a rear end of the first tube 11 to move the block position 22 to the second position. At this time, the third resilient member 24 and the positioning ball 26 are moved to and inside the positioning recess 113, and the stubs 221 are not aligned with the cavities 311 and abut with the inner surface 301 of the pressing portion 31. Accordingly, when the pressing portion 31 is in contact, the pressing portion 31 is kept from being pressed by the block of the stubs 221. Therefore, when the block portion 22 of the press-proof member 20 is moved to the first position on the outer side 111 of the first tube 11, the pressing portion 31 of the press-proof member 30 is radially moved a first distance relative to the outer side 111 of the first tube 11. When the block portion 22 of the press-proof member 20 is moved to the second position on the outer side 111 of the first tube 11, the pressing portion 31 of the press-proof member 30 is radially moved a second distance relative to the outer side 111 of the first tube 11. The second distance is shorter than the first distance. In the first embodiment, the second distance due to the block portion 22 of the press-proof member 20 being moved to the second position on the outer side 111 of the first tube 11 is 0 as shown in FIG. 4C and is shorter than the first distance due to the block portion 22 of the press-proof member 20 being moved to the first position on the outer side 111 of the first tube 11 as shown in FIG. 4A.

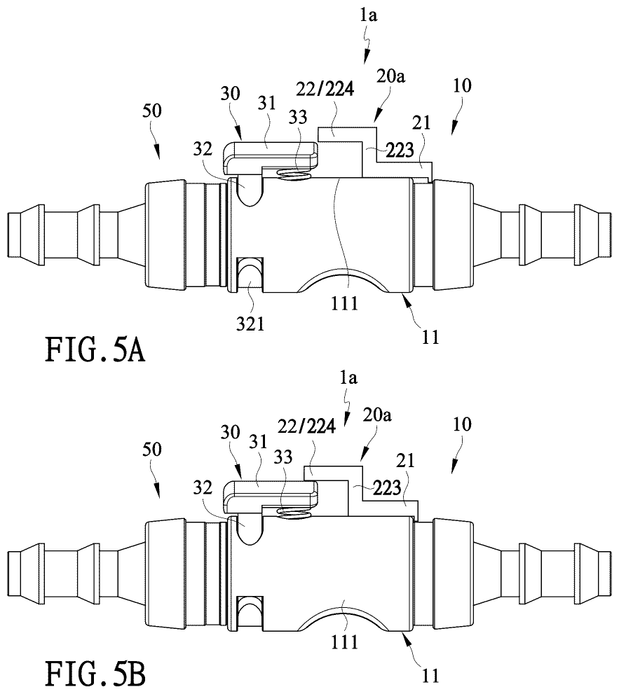

With reference to FIGS. 5A and 5B, a second embodiment of an axis push type waterproof connector assembly 1a is shown that has a structure same as that in the first embodiment except that the block portion 22 of the press-proof member 20a protrudes longitudinally from the pushing portion 21 toward the first front opening 12 in the first tube 11 and is L-shaped. The block portion 22 comprises a vertical board 223 and lateral board 224. The lateral board 224 is higher than the pressing portion 31 relative to the outer side 111 of the first tube 11 and is located at a position outside the pressing portion 31. The lateral board 224 integrally connects the pushing portion 21 by the vertical board 223. In addition, the first position and the second position in the present embodiment are opposite the first position and the second position in the first embodiment. As shown in FIG. 5A, when the block portion 22 is moved backward to the first position, the lateral board 24 is not overlapped with the pressing portion 31 in the radial direction. As shown in FIG. 5B, when the block portion 22 is moved backward to the second position, the lateral board 24 is overlapped with the pressing portion 31 in the radial direction. Thus, when the pressing portion 31 is in accident contact, the pressing portion 31 is blocked by the lateral board 224 of the block portion 22 and is kept from being pressed downward. Accordingly, in the present embodiment, when the press-proof 20a is moved to the second position on the outer side 111 of the first tube 11, a second distance of the pressing portion 31 being moved radially relative to the outer side 111 of the first tube 11 is 0 and is shorter than a first distance of the pressing portion 31 due to the press-proof member 20a being moved to the first position on the outer side 111 of the first tube 11.

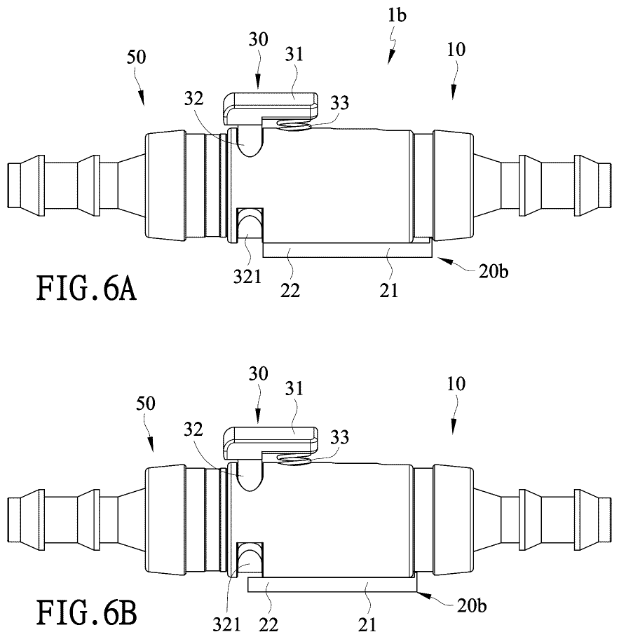

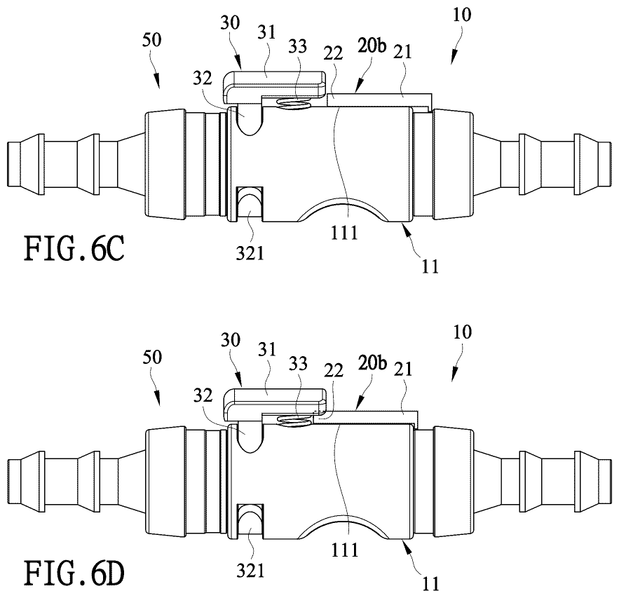

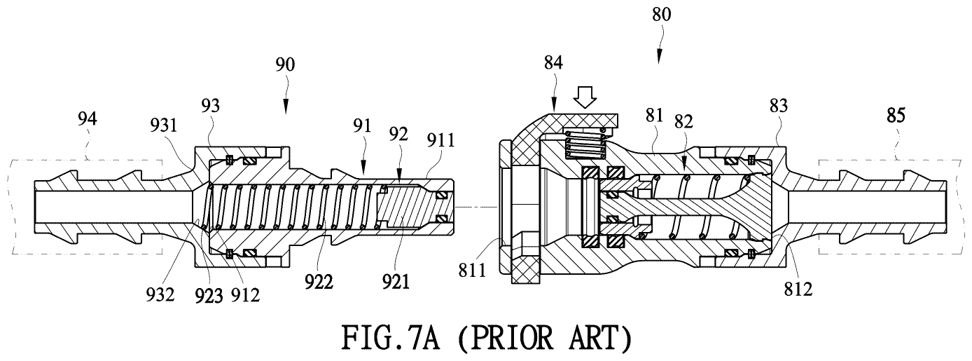

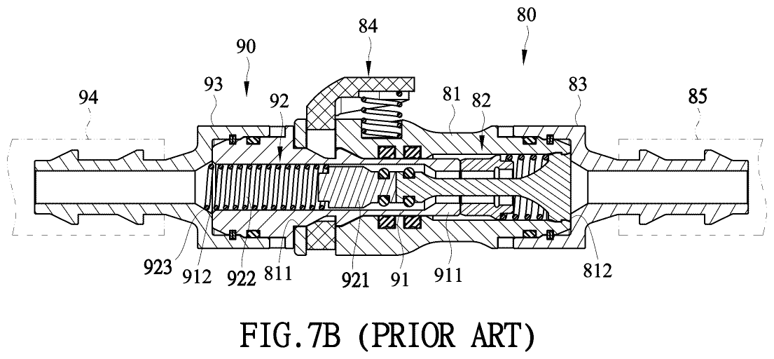

With reference to FIGS. 6A and 6B, a third embodiment of an axis push type waterproof connector assembly 1b is shown that has a structure same as that in the second embodiment except that the block portion 22 of the press-proof member 20b protrudes longitudinally from the pushing portion 21 toward the first front opening 12 in the first tube 11 and is flush with the pushing portion 21. In one embodiment, the block portion 22 has a thickness same as that of the pushing portion 21. As shown in FIG. 6A, when the block portion 22 is moved longitudinally to the first position, the block position is not at a position where can block the lower portion 321 of the engaging portion 32 protruding out of the first tube 11. As shown in FIG. 6B, when the block portion 22 is moved longitudinally to the second position, the block position is at the position where can block the lower portion 321 of the engaging portion 32 protruding out of the first tube 11. Thus, when the pressing portion 31 is pressed downward due to accident contact, the engaging portion 32 can be kept from being moved downward and protruding out of the first tube 11. Accordingly, the male waterproof connector 50 is prevented from being disengaged from the female waterproof connector 10. In the present embodiment, when the press-proof member 20b is moved to the second position on the outer side 111 of the first tube 11, a second distance of the pressing portion 31 radially relative to the outer side 111 of the first tube 11 is 0 and is shorter than a first distance of the pressing portion 31 due to the press-proof member 20b being moved to the first position on the outer side 111 of the first tube 11. With reference to FIGS. 6C and 6D, in another embodiment, the press-proof member 20 and the pressing portion 31 are disposed on a same side of the outer side 111 of the first tube 11. Accordingly, when the press-proof member 20 is moved longitudinally backward to the first position, the block portion 22 and the pushing portion 21 are both not overlapped with the pressing portion 31 in the radial direction. Thus, the block portion 22 is not at a position between the pressing portion 31 and the outer side 111 of the first tube 11. At this time, the pressing portion 31 is allowed to be pressed to make the lower portion 321 of the engaging portion 32 protrude out of the outer side 111 of the first tube 11. As shown in FIG. 6D, when the block portion 22 is moved longitudinally backward to the second position, the block portion 22 is located between the pressing portion 31 and the outer side 111 of the first tube 11 and is overlapped with the pressing portion 31 in the radial direction. The pressing portion 31 is blocked to prevent from being pressed. Therefore, in the present embodiment, when the press-proof member 20b is moved to the second position on the outer side 111 of the first tube 11, a second distance of the pressing portion 31 being moved radially relative to the outer side 111 of the first tube 11 is 0 and is shorter than a first distance of the pressing portion 31 due to the press-proof member 20b being moved to the first position on the outer side 111 of the first tube 11.

With reference to FIGS. 2 and 3, the first water connector 25 is mounted around the outer side 111 of the first tube 11 and communicates with the first rear opening 13 of the first tube 11. A first neck tube 251 is formed on an end of the first water connector 25 and communicates with the first rear opening 13 of the first tube 11. The first neck tube 251 has a first end face 252 and a first inner diameter Rᵣ₁, and the first inner diameter Rᵣ₁ is smaller than the diameter R_{B1} of the first rear opening 13.

The first valve 40 comprises a fixed valve element 41. A first moving valve element 42, and a first spring 43. A front end 411 of the fixed valve element 42 is flush with the vertical face 142 of the neck flange 14, and a rear end 412 of the fixed valve element 42 abuts with the first end face 252 of the first neck tube 251 of the first water connector 25. The first moving valve element 42 is mounted slidably around the front end 411 of the fixed valve element 41 and is shorter than the fixed valve element 41. The first moving valve element 42 abuts with the vertical face 142 of the neck flange 14. A second seal 421 is mounted around an outer side 111 of the first moving valve element 42. The second seal 421 abuts against an inner surface of the first tube 11. The first spring 43 is mounted around the fixed valve element 41. Two ends of the first spring 43 abuts respectively against the first moving valve element 42 and the rear end 412 of the fixed valve element 41.

The male waterproof connector 50 comprises a second tube 51, a second water connector 60, and a second valve 70. The second tube 51 comprises a front insertion portion 52 and a rear connection portion 53. The front insertion portion 52 of the second tube 50 has a diameter matching the diameter R_{N} of the neck flange 14. A hook portion 521 is formed on an outer side of the front insertion portion 52 has an outer surface corresponding to the inclined surface 141 of the neck flange 14 is shape. The front insertion portion 52 has a second front opening 522. The rear connection portion 52 integrally connect to the front insertion portion 52 and has a second rear opening 531.

The second water connector 60 is mounted around an outer side of the rear connection portion 53 of the second tube 51. A second neck tube 61 is formed on the second water connector 60 and communicates with the second rear opening 531 of the second tube 51. The second neck tube 61 has a second end face 611 and a second inner diameter Rᵣ₂. An inner diameter R_{T2} of the second tube 51 is larger than an inner diameter R_{F2} of the second front opening 522. The inner diameter R_{F2} of the second front opening 522 is larger than the second inner diameter Rᵣ₂ of the second neck tube 61 (R_{T2}>R_{F2}>Rᵣ₂). The second inner diameter Rᵣ₂ is smaller than an inner diameter R_{B2} of the second rear opening 531. In one embodiment, the inner diameter RF2 of the second front opening 522 minus the second inner diameter Rᵣ₂ of the second neck tube 61 is smaller than 0.7 mm.

The second valve 70 comprises a second moving valve element 71 and a second spring 72. A front end of the second moving valve element 71 is flush with the second front opening 522. A third seal 711 is mounted around an outer side of the second moving valve element 71. An end 721 of the second spring 72 abuts with a rear end of the second moving valve element 71, and the other end 722 of the second spring 72 abuts with the second end face 611 of the second neck tube 61 of the second water connector 60.

With reference to FIGS. 3 and 4A, the front insertion portion 52 of the male waterproof connector 50 is inserted into the female waterproof connector 10 via the first front opening 12. The front insertion portion 52 extends smoothly through the neck flange 14 and abuts with and pushes the first moving valve element 42 of the first valve 40 to move backward. The first spring 43 is compressed until the hook portion 521 of the front insertion portion 52 is attached with and abuts with the inclined surface 141 of the neck flange 14. The front end 411 of the fixed valve element 41 enters the second front opening 522 of the front insertion portion 52 and pushes the second moving valve element 71 of the second valve 70 to move in a reverse direction. The second spring 72 is compressed. At this time, the lower portion 321 of the engaging portion 32 of the pressed buckle 30 will be engaged with the hook portion 521 to lock the front insertion portion 52 of the male waterproof connector 50 inside the first tube 11 of the female waterproof connector 10. During the period of insertion, the second seal 421 on the first moving valve element 42 is moved with the first moving valve element 42 and abut against the inner surface of the first tube 11 to provide a water-sealing effect. On the contrary, to pull the front insertion portion 52 of the male waterproof connector 50 out of the female waterproof connector 10 via the first front opening 12, the pressing portion 31 is press to disengage the lower portion 321 of the engaging portion 32 from the hook portion 521. Thus, the front insertion portion 52 can be pulled backward (in a direction away from the first front opening 12). At this time, the compressed first spring 43 and the second spring 72 provide restoring forces respectively to the first moving valve element 42 and the second moving valve element 71 to push the first moving valve element 42 and the second moving valve element 71 to the original positions as shown in FIG. 3.

With such an arrangement, the axis push type waterproof connector assembly is mainly applied a press-proof member longitudinally movable onto an outer side of the first tube 11 of the female waterproof connector. When the press-proof member is moved respectively to the first position and the second position on the outer side of the first tube, the moving distance of the pressing portion of the press-proof member relative to the outer side of the first tube can be adjusted. This means that after the axis push type waterproof connector assembly is assembled, the press-proof member is moved to the second position to limit the diametrical movable distance of the pressed buckle is not enough to disengage the male waterproof connector from the female waterproof connector.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An axis push type waterproof connector assembly comprising a female waterproof connector and a male waterproof connector selectively inserted into the female waterproof connector, wherein a pressed buckle of the female waterproof connector is disposed on an outer side of a first tube of the female waterproof connector at a spaced interval, a second tube of the male waterproof connector held in the female waterproof connector is engaged with or disengaged from the pressed buckle by a diametrical movement of the pressed buckle, and characterized in that
a press-proof member is mounted on the outer side of the first tube of the female waterproof connector and comprises
a pushing portion mounted longitudinally moveably on the outer side of the first tube and being free from being overlapped with the pressed buckle in a radial direction of the first tube; and
a block portion integrally protruding from a front end of the pushing portion and being movable with the pushing portion between a first position and a second position of the outer side of the first tube, wherein
when the block portion is moved to the first position of the outer side of the first tube, the pressing portion of the pressed buckle is moved relative to the outer side of the first tube at a first distance in the radial direction of the first tube; and
when the block portion is moved to the second position of the outer side of the first tube, the pressing portion of the pressed buckle is moved relative to the outer side of the first tube at a second distance in the radial direction of the first tube, wherein the second distance is shorter than the first distance.

2. The connector assembly as claimed in claim 1, wherein
the pressing portion has a thickness and a cavity defined in an inner surface of the pressing portion to fit with the block portion, wherein the thickness of the pressing portion is larger a depth of the cavity;
the block portion and the pressing portion are overlapped with each other in the radial direction at a position between the outer side of the first tube and the inner surface of the pressing portion;
when the block portion is moved to the first position, the block portion is located between the pressing portion of the pressed buckle and the outer side of the first tube; and
when the block portion is moved to the second position, the block portion is located between the pressing portion of the pressed buckle and the outer side of the first tube but is free from being aligned with the cavity, wherein the first position is more close to the male waterproof connector than the second position.

3. The connector assembly as claimed in claim 2, wherein the block portion comprises
a board body abutting with the outer side of the first tube, being spaced from the inner surface of the pressing portion at a spaced interval, and being thinner than the pushing portion; and
at least one stub formed integrally on the board body and facing to the inner surface of the pressing portion, wherein at least one cavity is defined in the inner surface of the pressing portion, when the block portion is moved to the first position, each one of the at least one stub is aligned with one of the at least one cavity.

4. The connector assembly as claimed in claim 3, wherein
the pressed buckle further comprises a first resilient member disposed between the inner surface of the pressing portion and the outer side of the first tube;
a notch is defined in the board body of the block portion at a position corresponding to the first resilient member, and the first resilient member extends through the notch;
the at least one stub is implemented as two stubs respectively located at two sides of the notch; and
the at least one cavity defined in the inner surface of the pressing portion is implemented as two cavities corresponding respectively to the two stubs in position.

5. The connector assembly as claimed in claim 1, wherein
the block portion is L-shaped and includes a vertical board and a lateral board, the lateral board is higher than the pressing portion relative to the outer side of the first tube and is located at a position outside the pressing portion, and the lateral board integrally connects to the pushing portion by the vertical board;
when the block portion is moved to the first position, the lateral board is free from being overlapped with the pressing portion in the radial direction; and
when the block portion is moved to the second position, the lateral board is overlapped with the pressing portion in the radial direction, wherein the second position is more close to the male waterproof connector than the first position.

6. The connector assembly as claimed in claim 1, wherein
the block portion of the press-proof member protrudes longitudinally from the pushing portion and is flush with the pushing portion;
when the block portion is moved to the first position, the block portion is free from being overlapped with the pressing portion in the radial direction; and
when the block portion is moved to the second position, the block portion is located between the pressing portion and the outer side of the first tube and is overlapped with the pressing portion in the radial direction, wherein the second position is more close to the male waterproof connector than the first position.

7. The connector assembly as claimed in claim 1, wherein
the pressed buckle further comprises
an engaging portion protruding integrally from the pressing portion, extending diametrically through the first tube, and selectively protruding out of the first tube; and
a first resilient member disposed between an inner surface of the pressing portion and the outer side of the first tube;
when the block portion is moved to the first position, the block portion is free from being located at a position where a lower portion of the engaging portion protrudes out of the first tube; and
when the block portion is moved to the second position, the block portion is located at a position where a lower portion of the engaging portion protrudes out of the first tube to limit a protruding distance of the engaging portion, wherein the second position is more close to the male waterproof connector than the first position.

8. The connector assembly as claimed in claim 1, wherein
a holding recess is defined in the outer side of the first tube at a position corresponding to the pushing portion of the press-proof member, and a positioning recess is defined in a bottom of the holding recess;
the pushing portion of the press-proof member is mounted slidably in the holding recess and has a sliding block protruding toward the holding recess and flatly attached to the bottom of the holding recess, and the press-proof member further comprises
a second resilient member mounted longitudinally between the pushing portion and an inner wall of the holding recess;
a third resilient member mounted in the sliding block in the radial direction of the first tube; and
a positioning ball held in the positioning recess and pushed by the third resilient member, wherein when the block portion is moved to the first position, the positioning ball is moved longitudinally from the positioning recess to the bottom of the holding recess, and when the block portion is moved to the second position, the positioning ball is moved to and inside the positioning recess by a force provided by the third resilient member.

9. The connector assembly as claimed in claim 1, wherein
the female waterproof connector comprises
a first valve mounted in the first tube;
the pressed buckle further comprises
an engaging portion protruding integrally from the pressing portion, extending diametrically through the first tube, located at a position being approaching to the a first front opening of the first tube, and being annular; and
a first resilient member disposed between the pressing portion and the outer side of the first tube; and
a first water connector connecting to the first tube and communicating with a first rear opening of the first tube; and
the male waterproof connector comprises
a second valve mounted in the second tube;
a front insertion portion having a second front opening, a hook portion formed on an outer side of the front insertion portion, wherein when the front insertion portion is inserted into the first tube of the female waterproof connector, the front insertion portion extends through the engaging portion of the press-proof member and the hook portion is engaged with the engaging portion; and
a rear connection portion connecting to the front insertion portion and having a second rear opening; and
a second water connector connecting to the rear connection portion of the second tube and communicating with the rear opening of the rear connection portion.

10. The connector assembly as claimed in claim 9, wherein
a neck flange protrudes from an inner surface of the first tube at a position being approaching to the first front opening, and has two opposite surfaces and a flat surface, wherein the two opposite surfaces include an inclined surface facing the first front opening and a vertical surface facing the first rear opening, and a first seal is embedded in the flat surface;
the first water connector is mounted around the outer side of the first tube, and a first neck tube is formed on an end of the first water connector, communicates with the first rear opening of the first tube, and has a first end face;
the first valve comprises
a fixed valve element having a front end being flush with the vertical surface of the neck flange and a rear end abutting with the first end face of the first neck tube of the first water connector;
a first moving valve element mounted slidably around the fixed valve element, being shorter than the fixed valve element, and abutting with the vertical surface of the neck flange, a second seal mounted around the first moving valve element and abutting against an inner surface of the first tube, wherein an inner diameter of the inner surface of the first tube is larger than an inner diameter of the neck flange but is smaller than a diameter of the first front opening; and
a first spring mounted around the fixed valve element and having two ends abutting respectively with the first moving valve element and a rear end of the fixed valve element;
a diameter of the front insertion portion of the second tube matches the inner diameter of the neck flange of the first tube;
the second water connector is mounted around the rear connection portion of the second tube, and a second neck tube is formed on an end of the second water connector, communicates with the second rear opening of the second tube, and has a second end face and a second inner diameter smaller than a diameter of the second rear opening, wherein an inner diameter of the second tube is larger than a diameter of the second front opening, the diameter of the second front opening is larger than the second inner diameter of the second neck tube; and
the second valve comprises
a second moving valve element having a front end being flush with the second front opening, selectively abutting with the fixed valve element of the first valve, and a third seal mounted around the second moving valve element; and
a second spring mounted around an outer side of the second tube and having two ends abutting respectively with a rear end of the second moving valve element and the second end face of the second neck tube of the second water connector.

11. The connector assembly as claimed in claim 10, wherein the diameter of the second front opening minus the second inner diameter of the second neck tube is smaller than 0.7mm.

12. A female waterproof connector comprising
a first tube comprising a first front opening and a first rear opening;
a pressed buckle comprising a pressing portion and an engaging portion, wherein the pressing portion is mounted on an outer side of the first tube at a spaced interval, the engaging portion protruding integrally from the pressing portion, extending diametrically through the first tube, and being approaching to the first front opening of the first tube;
a press-proof member mounted on the outer side of the first tube and comprising
a pushing portion mounted longitudinally slidably on the outer side of the first tube and is free from being overlapped with the pressed buckle in a radial direction of the first tube; and
a block portion protruding integrally from a front end of the pushing portion and pushed by the pushing portion to move between a first position and a second position on the outer side of the first tube, wherein
when the block portion is moved to the first position of the outer side of the first tube, the pressing portion of the pressed buckle is moved relative to the outer side of the first tube at a first distance in the radial direction of the first tube; and
when the block portion is moved to the second position of the outer side of the first tube, the pressing portion of the pressed buckle is moved relative to the outer side of the first tube at a second distance in the radial direction of the first tube, wherein the second distance is shorter than the first distance.

13. The female waterproof connector as claimed in claim 12, wherein
the pressing portion has a thickness and a cavity defined in an inner surface of the pressing portion to fit with the block portion, wherein the thickness of the pressing portion is larger a depth of the cavity;
the block portion and the pressing portion are overlapped with each other in the radial direction at a position between the outer side of the first tube and the inner surface of the pressing portion;
when the block portion is moved to the first position, the block portion is located between the pressing portion of the pressed buckle and the outer side of the first tube; and
when the block portion is moved to the second position, the block portion is located between the pressing portion of the pressed buckle and the outer side of the first tube but is free from being aligned with the cavity, wherein the first position is more close to the male waterproof connector than the second position.

14. The female waterproof connector as claimed in claim 13, wherein the block portion comprises
a board body abutting with the outer side of the first tube, being spaced from the inner surface of the pressing portion at a spaced interval, and being thinner than the pushing portion; and
at least one stub formed integrally on the board body and facing to the inner surface of the pressing portion, wherein at least one cavity is defined in the inner surface of the pressing portion, when the block portion is moved to the first position, each one of the at least one stub is aligned with one of the at least one cavity.

15. The female waterproof connector as claimed in claim 14, wherein
the pressed buckle further comprises a first resilient member disposed between the inner surface of the pressing portion and the outer side of the first tube;
a notch is defined in the board body of the block portion at a position corresponding to the first resilient member, and the first resilient member extends through the notch;
the at least one stub is implemented as two stubs respectively located at two sides of the notch; and
the at least one cavity defined in the inner surface of the pressing portion is implemented as two cavities corresponding respectively to the two stubs in position.

16. The female waterproof connector as claimed in claim 12, wherein
the block portion is L-shaped and includes a vertical board and a lateral board, the lateral board is higher than the pressing portion relative to the outer side of the first tube and is located at a position outside the pressing portion, and the lateral board integrally connects to the pushing portion by the vertical board;
when the block portion is moved to the first position, the lateral board is free from being overlapped with the pressing portion in the radial direction; and
when the block portion is moved to the second position, the lateral board is overlapped with the pressing portion in the radial direction, wherein the second position is more close to the first front opening than the first position.

17. The female waterproof connector as claimed in claim 12, wherein
the block portion of the press-proof member protrudes longitudinally from the pushing portion and is flush with the pushing portion;
when the block portion is moved to the first position, the block portion is free from being overlapped with the pressing portion in the radial direction; and
when the block portion is moved to the second position, the block portion is located between the pressing portion and the outer side of the first tube and is overlapped with the pressing portion in the radial direction, wherein the second position is more close to the first front opening than the first position.

18. The female waterproof connector as claimed in claim 12, wherein
a holding recess is defined in the outer side of the first tube at a position corresponding to the pushing portion of the press-proof member, and a positioning recess is defined in a bottom of the holding recess;
the pushing portion of the press-proof member is mounted slidably in the holding recess and has a sliding block protruding toward the holding recess and flatly attached to the bottom of the holding recess, and the press-proof member further comprises
a second resilient member mounted longitudinally between the pushing portion and an inner wall of the holding recess;
a third resilient member mounted in the sliding block in the radial direction of the first tube; and
a positioning ball held in the positioning recess and pushed by the third resilient member, wherein when the block portion is moved to the first position, the positioning ball is moved longitudinally from the positioning recess to the bottom of the holding recess, and when the block portion is moved to the second position, the positioning ball is moved to and inside the positioning recess by a force provided by the third resilient member.

19. The female waterproof connector as claimed in claim 12, wherein
a holding recess is defined in the outer side of the first tube at a position corresponding to the pushing portion of the press-proof member, and a positioning recess is defined in a bottom of the holding recess;
the pushing portion of the press-proof member is mounted slidably in the holding recess and has a sliding block protruding toward the holding recess and flatly attached to the bottom of the holding recess, and the press-proof member further comprises
a second resilient member mounted longitudinally between the pushing portion and an inner wall of the holding recess;
a third resilient member mounted in the sliding block in the radial direction of the first tube; and
a positioning ball held in the positioning recess and pushed by the third resilient member, wherein when the block portion is moved to the first position, the positioning ball is moved longitudinally from the positioning recess to the bottom of the holding recess, and when the block portion is moved to the second position, the positioning ball is moved to and inside the positioning recess by a force provided by the third resilient member.

20. The female waterproof connector as claimed in claim 12, wherein
the female waterproof connector comprises
a first valve mounted in the first tube;
the pressed buckle further comprises
an engaging portion protruding integrally from the pressing portion, extending diametrically through the first tube, located at a position being approaching to the a first front opening of the first tube, and being annular; and
a first resilient member disposed between the pressing portion and the outer side of the first tube; and
a first water connector connecting to the first tube and communicating with a first rear opening of the first tube.

21. The female waterproof connector as claimed in claim 20, wherein
a neck flange protrudes from an inner surface of the first tube at a position being approaching to the first front opening, and has two opposite surfaces and a flat surface, wherein the two opposite surfaces include an inclined surface facing the first front opening and a vertical surface facing the first rear opening, and a first seal is embedded in the flat surface;
the first water connector is mounted around the outer side of the first tube, and a first neck tube is formed on an end of the first water connector, communicates with the first rear opening of the first tube, and has a first end face;
the first valve comprises
a fixed valve element having a front end being flush with the vertical surface of the neck flange and a rear end abutting with the first end face of the first neck tube of the first water connector;
a first moving valve element mounted slidably around the fixed valve element, being shorter than the fixed valve element, and abutting with the vertical surface of the neck flange, a second seal mounted around the first moving valve element and abutting against an inner surface of the first tube, wherein an inner diameter of the inner surface of the first tube is larger than an inner diameter of the neck flange but is smaller than a diameter of the first front opening; and
a first spring mounted around the fixed valve element and having two ends abutting respectively with the first moving valve element and a rear end of the fixed valve element.
